(19) United States
(12) Patent Application Publication
(10) Pub. No.: US 2020/0296814 A1
(43) Pub. Date: Sep. 17, 2020

(54) Lighting system and method for controlling the switching on of lights emitted from a plurality of lighting elements

(71) Applicant: Ledworks Srl, Milano (IT)

(72) Inventors: Marco Franciosa, Genova (IT); Andrea Tellatin, Mestrino (PD) (IT)

(21) Appl. No.: 16/646,455

(22) PCT Filed: Sep. 18, 2018
(86) PCT No.: PCT/IB2018/057168

§ 371 Date: Mar. 11, 2020

(30) Foreign Application Priority Data
Sep. 18, 2017 (IT) 102017000104175

(51) Int. Cl. H05B 47/155; H05B 45/30; H05B 47/165

(52) U.S. Cl. CPC H05B 47/155; H05B 47/165; H05B 45/30

(57) ABSTRACT

A lighting system includes a plurality of lighting members and a power source for those lighting members. The power source has of a plate-like member connected to an electrical power generation unit and a plurality of housing seats for removably attaching one or more lighting members, the housing seats being connected in parallel to the electrical power generation unit. A control unit is connected to the plate-like member and is configured to generate a control signal for the operation of the lighting members.

The present invention relates to a lighting system comprising a plurality of lighting members and a power source for said lighting members.

Particularly, the present invention relates to lighting systems for decorative purposes, preferably systems using LED-type devices as light members.

In systems known in the art, LED control is a particularly critical aspect, especially when it is desired to obtain systems which are not pre-configured but which can create various combinations of light effects and scenographies.

The critical issue in controlling LEDs is further exacerbated when coloured LEDs of the RGB-type are used instead of monochrome LEDs.

In fact, if it is desired to switch on or off a plurality of LEDs all together, then only two LED connectors and two wires for turning on/off the power are needed while, if it is desired to drive each LED individually, then a dedicated circuit from a control unit to the LED is required.

Such a configuration results in a high design complexity which increases the risk of system failure due to the high probability of breakage of one of the components.

A possible approach is using two-terminal LEDs; in this case, however, LEDs should comprise a smart unit to receive a signal from a control unit to indicate how the LED should light up.

Besides being provided with a smart unit, such LEDs should be identified by a unique code in such a way that the control unit can route the message precisely.

However, in order to create special sceneries and light effects, the position of each individual LED has to be known.

This aspect further increases the design complexity of a control method for such LEDs.

To date, in systems known in the art, the address of each LED is written before welding or connecting the LED to a power supply unit.

However, such an approach is disadvantageous.

In fact, mistakes can occur during the address allocation procedure and, in case of error or breakage of one of the LEDs, all the addresses have to be “manually” rechecked in order to find the error.

Therefore, there is a need—not satisfied by systems known in the art—for a lighting system and a control method for said system which can meet various operational requirements and ensure a high variety of possible configurations for the lighting members while allowing lighting members to be easily controlled by users at will.

The present invention achieves the above objects by providing a system as described above in which the power source consists of a plate-like member which is connected to an electrical power generation unit and provided with a plurality of housing seats to removably attach one or more lighting members.

Particularly, the housing seats are connected in parallel to the electrical power generation unit.

A control unit is also provided which is connected to the plate-like member and configured to generate a control signal for the operation of the lighting members.

The configuration described immediately above, whose characteristics will be described in detail below, allows a homogeneous electrical power distribution plane to be obtained without the need for dedicated circuits for each lighting member.

Moreover, as will be apparent below, the system according to the present invention can use any type of LEDs in any number, it allows to attach any number of LEDs to any one of the housing seats of the plate-like member and, as will be described with reference to the control method, it allows to know the position of each of the LEDs as well as to adjust the colour thereof on an individual base.

It will be apparent from the above that, due to the unique construction of the housing seats of the plate-like member and the lighting members, each lighting member can be fitted into any one of the housing seats.

Indeed, each lighting member can be removably engaged into a housing seat, and the contact between the terminals of the lighting members and the plate-like member is ensured without the need for welding or other approaches which make difficult for the lighting member to be removed from the housing seat.

Accordingly, it is contemplated that the lighting members can be removed from the power supply plate-like member, i.e. they can be removed from one position (housing seat) and moved to a new position, without changing the configuration of the system.

Thus, the power supply plate generates a distributional power signal which can feed the lighting members whose position is neither fixed nor known a priori.

Therefore, the detection of the position is a key factor, and this can be accomplished with the use of one of two approaches.

According to a first approach, it is contemplated that the lighting members may be positioned based on a series of fixed, predetermined arrangements in such a way that the lighting members are fitted into the housing seats according to precise patterns in order to generate predetermined shapes and choreographies.

For example, such patterns can be set forth in instruction manuals or stored within the control unit.

Alternatively, as will be described in detail below, it is contemplated that each lighting member may be provided with an identification code and the system may comprise an image acquisition unit in order to identify the position of each lighting member when engaged within a housing seat.

As will be seen below, the image acquisition unit may be incorporated within the control unit or a user-side unit.

In any case, it is apparent that a control unit which is able to generate and modulate control signals in order to control the lightning members and possibly know the position thereof is an essential component of the system.

According to a preferred variant embodiment, the plate-like member consists of at least two mutually overlapping conductive plates and a layer of an insulating material interposed between the two conductive plates.

In this case, each housing seat is formed as one hole for each conductive plate.

As a result, each lighting member has two terminals in such a way that, when in the attached condition, one terminal of each lighting member contacts one conductive plate and the other terminal contacts the other conductive plate.

Due to this configuration, the system according to the present invention can use LEDs known in the art and LEDs produced by equipment for the manufacture of two-terminal monochrome LEDs.

When only two terminals are used, the lighting member should comprise an identification code and be configured to respond to control signals comprising said identification code, for example through a smart unit incorporated within the lighting member.

Generally, the identification code is a binary code string specifying the address for each LED.

Another object of the system according to the present invention is to solve the problem related to the control of such a LED through the implementation of a specific control method.

Particularly, the method according to the present invention comprises the following steps:

a) connecting each lighting member in parallel to a common power source,

b) turning on each of said plurality of lighting members according to a respective switching-on sequence,

c) acquiring a sequence of images from the plurality of lighting members,

d) analysing the sequence of images in order to identify the unique binary code for each lighting member,

e) analysing the sequence of images in order to determine a spatial position for each lighting member,

f) generating a control signal for the lighting members in such a way that the lighting members emit lights according to a light pattern, said light pattern comprising switching on the LEDs according to a predetermined spatial order.

Advantageously, a user operating unit is provided, such as a smartphone or the like, to carry out the step of analysing the sequence of images.

The user operating unit can also be employed to select the light pattern which is used by the control unit as a basis to generate the control signal for turning on the lighting members.

Step b) of turning on the lighting members is crucial for the identification of the binary code, and it can be carried out according to different modes which will be described below in detail with reference to certain illustrated examples.

According to a first mode, the identification binary code for each lighting member may be known a priori.

In this case, the position can be detected according to the method described in document WO2017/115326.

Alternatively, the binary code for each lighting member may be not known and, if this is the case, a pre-configuration step can be provided which comprises the following sub-steps:

b1) identifying at least one bit having a predetermined value,

b2) switching on all the lighting members having an identical value at the same bit,

b3) repeating steps b1) and b2) for each remaining bit in said unique binary code.

This allows the address of the LED to be determined uniquely without having to know it a priori and with a number of switching-on events corresponding to the number of bits in the code.

It is possible to use random addresses and then determine both the address and the position.

Such a process is carried out based on the analysis of the sequence of images, i.e. through a computer vision process which can determine not only the address but also the position of each LED so as to obtain the full recognition of all the LEDs based on both the address and the position, particularly the position on the plate-shaped member.

Moreover, such a variant allows the manufacture process for the components of the system to be simplified by leaving the pre-configuration step in the hands of the end user who will identify both the binary code and the position for each LED.

According to an improvement of the methodology described just above, the lighting member is adapted to emit lights of different colours in such a way that, during the acquisition of said plurality of images, each lighting member is controlled to generate a specific sequence of colours associated with the unique binary code of the lighting member which implements it.

The described method according to the present invention is particularly effective in conjunction with the system according to the present invention.

As such, the step of connecting the lighting members comprises fitting at least a part of the lighting members into the housing seats of the plate-like member.

Finally, according to a further embodiment aimed to increase the adaptability of the system according the present invention to the needs of the users, the plate-like member has connecting means at the peripheral edges thereof for connection to additional plate-like members.

It will be apparent from the above description that the system according to the present invention can be configured in several ways and can produce the most various light effects.

The ability to removably fit the LEDs into any one of the positions of the plate-like member and to control them by means of a user operating unit gives the system a high adaptability and reusability.

These and other features and advantages of the present invention will appear more clearly from the following description of certain exemplary embodiments as illustrated in the accompanying drawings, in which:

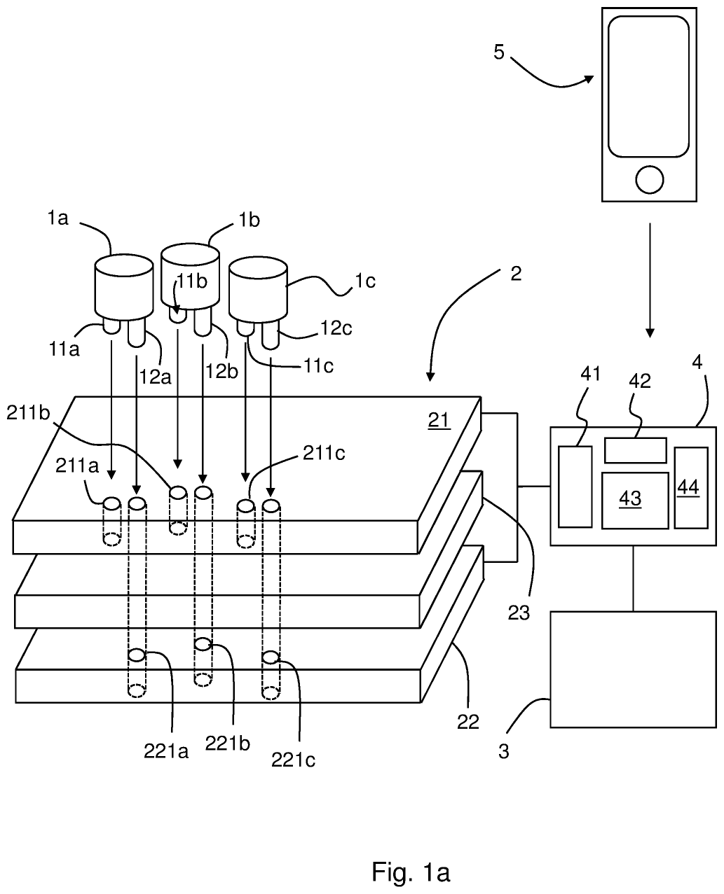

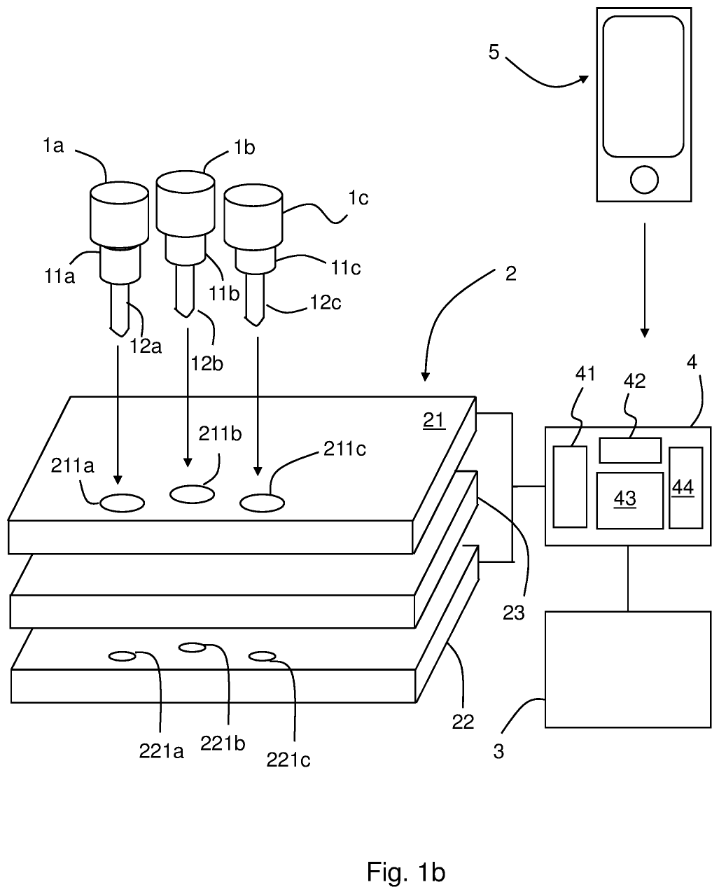

FIGS 1a and 1b illustrate two embodiments of the system according to the present invention;

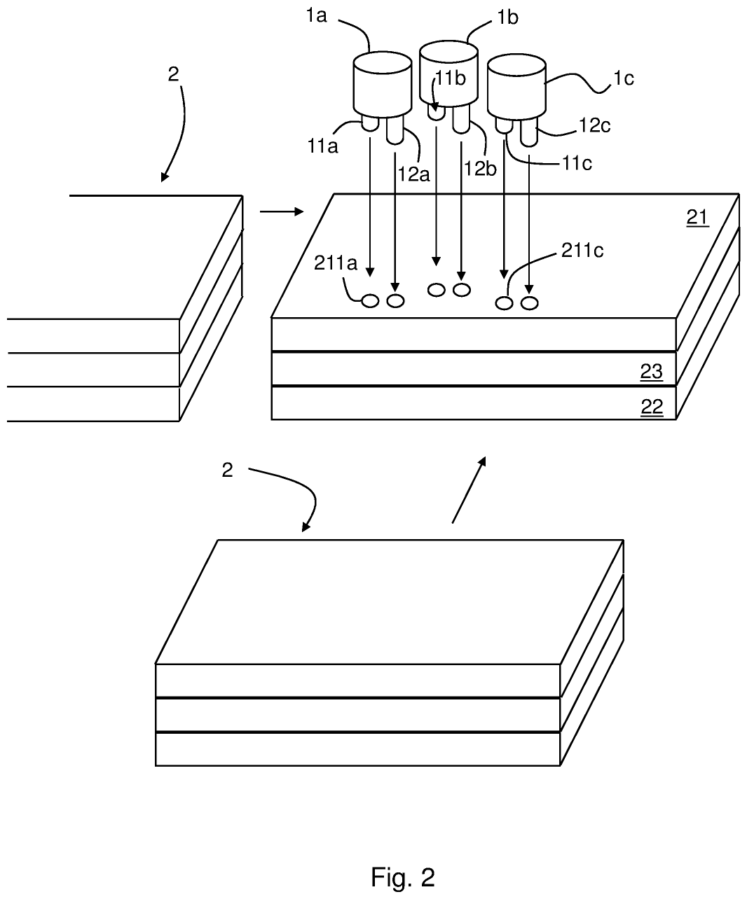

FIG. 2 illustrates a variant embodiment of the system of FIG. 1;

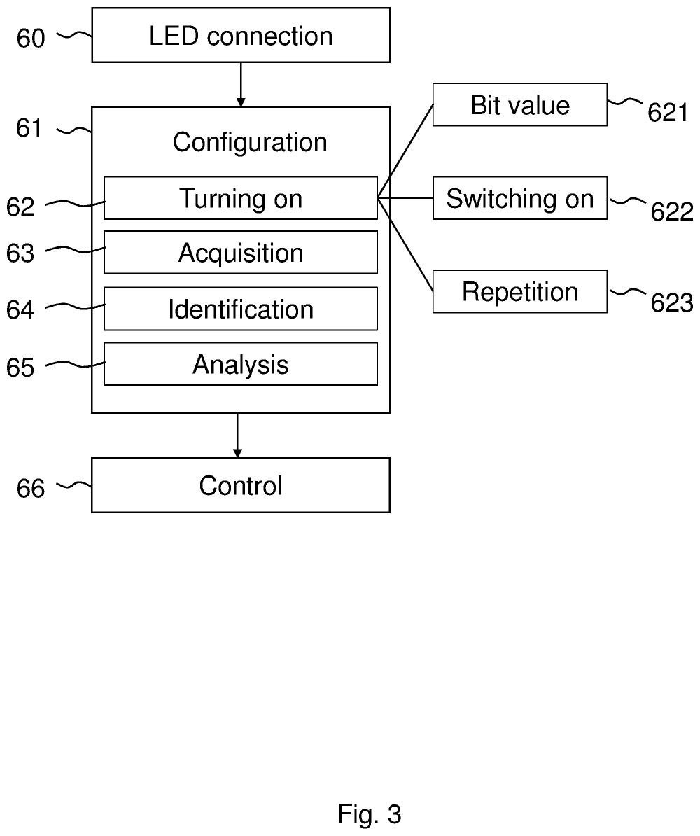

FIG. 3 illustrates a flow diagram related to the method according to the present invention.

It will be appreciated that the figures accompanying the present application illustrate certain embodiments of the system and method according to the present invention for a better understanding of the described advantages and characteristics.

Therefore, such embodiments are intended to be merely illustrative and not limitative of the inventive concept of the present invention, which is to obtain a lighting system and a lighting control method which can be easily configured and adapted to the needs of an end user.

Particularly, FIG. 1a illustrates a preferred embodiment of the system according to the present invention, comprising a plurality of lighting members—i.e. LEDs 1a, 1b and 1c—which can be removably attached to a plate-like member 2 connected to an electrical power generation unit.

For example, the electrical power generation unit can be a battery 3 or a mains network.

FIGS. 1a and 1b illustrate only three LEDs for sake of simplicity, but it will be apparent from the above description that LEDs can be provided in any number without departing from the characteristics of the system.

LEDs 1a-1c can be attached to housing seats formed in the plate-like member 2.

Moreover, a control unit 4 is provided between the plate-like member 2 and the battery 3, said control unit being adapted to generate a control signal for the operation of LEDs.

The plate-like member 2 is formed by two mutually overlapping conductive plates 21, 22 and a layer of an insulating material 23 interposed between the two conductive plates 21 and 22.

Each housing seat is formed as one hole for each conductive plate 21, 22, particularly holes 211a, 221a for LED la, holes 211b, 221b for LED 1b, and holes 211c, 221c for LED 1c.

Each LED has two terminals 11a, 12a, 11b, 12b, 11c, 12c in such a way that, when in the attached state, one terminal of each LED contacts one conductive plate 21 and the other terminal contacts the other conductive plate 22.

For example, when in the attached state, terminal 11b of LED 1b is fitted in hole 211b and connected to plate 21, and terminal 12b is fitted in hole 221b and connected to plate 22.

Once LEDs 1a-1c are fitted in the appropriate housing seats, conductive plates 21 and 22 provide the power required to turn on the LEDs because the contact of the terminals with both the plates allows LEDs to be connected to the battery 3 without the need for additional connection wires.

LEDs 1a-1c are removably fitted in the plate-like member 2: indeed, terminals 11a-12c of LEDs are pins which are fitted into the housing seats in such a way that these pins contact the conductive plates 21 and 22.

Power transmission is enabled by a physical and positional contact of the terminals without the need for welding or other attachment methods which do not allow LEDs 1a-1c to be easily removed from the plate-like member 2.

This unique configuration allows LEDs 1a-1c to be fitted into and removed from the housing seats in an easy and reversible manner.

According to the described configuration, each LED 1a-1c comprises a unique identification code and is configured to respond to control signals comprising said identification code.

Furthermore, the control unit 4 allows the operation of LEDs 1a-1c to be adjusted not only for switch on/off purposes but also to change the colour in which the LEDs has to be switched on.

The control unit 4 generates a control signal which is a modulation of the power supply signal transmitted by the conductive plates 21 and 22 so as to enable switching on/off or changing of the specific colour for each LED due to the presence of the unique code which allows the control signal to be routed in a specific and separate manner for each LED.

Such a modulation allows both operational power and colour information to be transmitted to LEDs 1a-1c in real time.

The generation of the control signal and therefore the modulation of the power supply signal occur due to the presence of a modulation board 41 and based on a light pattern which is stored in a storage unit 42 of the control unit 4.

The control unit 4 also comprises processor means 43 to execute instructions for the generation of a light pattern.

The system according to the present invention can further comprise a user operating unit 5 which communicates with the control unit 4 through a communication module 44 of the control unit.

For example, the user operating unit 5 can be a device such as a smartphone or the like.

The presence of a smartphone or other device provided with video acquisition means is crucial for the implementation of a methodology aimed to determine the identification code (address) and the position of LEDs on the plate-like member 2, as will be described in detail in FIG. 3.

Such a methodology allows to identify a given LED and the housing seat in which it is fitted.

On the basis of this information, it will be possible to control the switching on of each LED individually and, particularly, a software application running on the smartphone 5 will allows to turn on each LED in a different colour according to a map available on the smartphone, to apply light motion effects, or to store these static or motion effects into the storage unit 42 of the control unit 4.

The same considerations also apply to Figure lb: the operation of the system according to the present invention is the same as that described for FIG. 1a.

Particularly, the two Figures differ in the arrangement of terminals 11a-12c for LEDs 1a-1c: in FIG. 1a, such terminals are arranged side by side for each LED, while in FIG. 1b, the terminals are arranged concentrically so as to have coincident longitudinal axes just like the common power cable connectors known in the art.

Before going into detail of the characteristics of the method for the control of light members, FIG. 2 illustrates a possible embodiment in which the plate-like member 2 has connecting means at the peripheral edges thereof for connection to additional plate-like members 2.

The connecting means can be of any type known in the art as long as they can electrically connect the conductive plates 21 and 22 to corresponding conductive plates of an additional plate-like member 2 which is arranged adjacent to a peripheral edge of the plate-like member 2.

For example, it is possible to provide jumpers from one plate-like member to the other.

Due to the particular construction of the system according to the present invention, the joining of two or more plate-like members 2 does not pose any problem in controlling the LEDs by the control unit 4, which can identify the housing seats of the various plate-like members 2 which are occupied in order to identify the position and address of the connected LEDs.

FIG. 3 illustrates one embodiment of a method for controllable switching of lights emitted by a plurality of lighting members according to the present invention.

As anticipated, such a method comprises performing a configuration step to identify the unique identification code for each LED and the position thereof.

The method is described with reference to one or more LEDs 1a-1c made according to the characteristics illustrated above and fitted in the housing seats of the plate-like member 2, but such a method can be also applied to any number of lighting members having unique identification codes and positioned according to any arrangement within an environment.

Generally, the unique identification code for each LED is a binary code adapted to indicate the address of each LED.

The LEDs are fitted into the housing seats so as to be connected in parallel to the electrical power generation unit—step 60.

Once the LEDs have been fitted, a system configuration step 61 is performed to identify the binary code and position for each LED.

Advantageously, the binary code is randomly assigned to each LED which is then fitted into a random housing seat of the plate-like member 2.

Assuming that the addresses of all LEDs are not known a priori, such a configuration step 61 comprises:
turning on each LED according to a respective switching-on sequence—step 62
acquiring a sequence of images from the plurality of LEDs—step 63
analysing the sequence of images in order to identify the unique binary code for each lighting member—step 64
analysing the sequence of images in order to determine a spatial position for each LED—step 65.

As a result, the configuration step 61 can obtain the binary code and position for each LED.

Once such an information has been obtained, a control step 66 is provided to generate a control signal for the LEDs in such a way that they emit lights according to a light pattern which comprises switching on the LEDs according to a predetermined spatial order.

According to the example shown in FIG. 3, a predetermined turning-on sequence can be provided—step 62—which particularly comprises:

b1) identifying at least one bit having a predetermined value in the unique binary code—step 621

b2) switching on all the LEDs having an identical value at the same bit—step 622

b3) repeating steps b1) and b2) for each remaining bit in said unique binary code—step 623.

For example, the control unit 4 can send a control signal—generated by the modulation described above—in which all the LEDs having a value of “1” at the first bit will light red and all the LEDs having a value of “0” at the first bit will light green.

It will be apparent that the repetition of this procedure for each bit in the unique binary code allows the code of each bit to be identified based on the analysis of the sequence of acquired images.

After the identification of the code, it is also possible to determine the position of each LED, once again based on the analysis of the acquired images for all the LEDs during the turning on sequence.

The steps described immediately above can also be used with monochrome LEDs, e.g. by setting all the LEDs having a value of “1” at the first bit as switched on and all the LEDs having a value of “0” at the first bit as switched off, and so forth.

Finally, as a further alternative, instead of identifying only one bit of the binary code—step 621, it is possible to identify a group of bits and switch on all the LEDs having the first four bits with a value of “1” in a given colour, for example.

The identified LEDs are isolated, and these LEDs are analysed on a per-bit basis as previously described.

Once the process has been completed, another group of LEDs having identical values at given bytes is processed, and so on up to process all the connected LEDs.

1. A lighting system comprising:
a plurality of lighting members;
a power source for said lighting members (1a-1c),
wherein said power source is a plate-shaped member (2) connected to an electrical power generation unit (3), said plate-shaped member (2) having a plurality of housing seats for removably attaching one or more of the lighting members (1a-1c), said housing seats being connected in parallel to said electrical power generation unit (3); and
a control unit (4) connected to said plate-shaped member (2) and configured to generate a control signal for operation of said lighting members (1a-1c).

2. The lighting system according to claim 1, wherein said plate-shaped member (2) is formed by at least two mutually overlapping conductive plates (21, 22) and a layer of an insulating material (23) which is interposed between the two conductive plates (21, 22),
each housing seat being formed as one hole (211a-221c) for each of the two conductive plate (21, 22),
each lighting member (1a-1c) comprising at least two terminals (11a-12c) so that, when in an attached state, one of the at least two terminals (11a-11c) of each lighting member (1a-1c) contacts one of the two conductive plates (21) and another one of the at least two terminals (12a-12c) contacts another one of the two conductive plates (22).

3. The lighting system according to claim 1, wherein each of the lighting members (1a-1c) comprises a unique identification code and is configured to respond to the control signal comprising said identification code.

4. The lighting system according to claim 1, further comprising a user operating unit (5) configured to communicate with said control unit (4).

5. The lighting system according to claim 1, wherein said plate-shaped member (2) has one or more connectors at peripheral edges for connection to another plate-shaped member.

6. A method of controlling a switching on of lights emitted by a plurality of lighting members (1a-1c), each lighting member (1a-1c) comprising a unique binary code, the method comprising:
a) connecting (60) each lighting member (11a-11c) in parallel to a common power source;
b) turning on (62) each of said plurality of lighting members according to a respective switching-on sequence;
c) acquiring (63) a sequence of images from the plurality of lighting members;
d) analyzing the sequence of images in order to identify (64) the unique binary code for each lighting member;
e) analyzing (65) the sequence of images in order to determine a spatial position for each lighting member; and
f) generating (66) a control signal for the lighting members so that the lighting members emit lights according to a light pattern, said light pattern comprising switching on the lighting members according to a predetermined spatial order.

7. The method according to claim 6, wherein step b) comprises the following sub-steps:
b1) identifying (621) at least one bit having a predetermined value in the unique binary code;
b2) switching on (622) all the lighting members having an identical value to the at least one bit; and
b3) repeating (623) steps b1) and b2) for each remaining bit in said unique binary code.

8. The method according to claim 6, wherein each of said plurality of lighting members is adapted to emit lights of different colors, and wherein, during the acquiring of said sequence of images, each lighting member is controlled to generate a specific sequence of colors, said specific sequence of colors being associated with the unique binary code of one of the lighting members which implements said specific sequence of colors.

9. The method according to claim 6, wherein step a) comprises fitting at least part of the lighting members into suitable housing seats formed through a thickness of a conductive plate-shaped member, said plate-shaped member being connected to an electrical power generation unit.

10. The method according to claim 6, wherein the light pattern is configured by a user through a user device, which is operatively connected to a control unit adapted to control the switching on of said plurality of lighting members.
